(19) United States
(12) Patent Application Publication
(10) Pub. No.: US 2008/0303325 A1
(43) Pub. Date: Dec. 11, 2008

(54) Child Seat for Vehicles

(75) Inventor: Markus Scholz, Waldenbuch (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/916,220

(22) PCT Filed: May 23, 2006
(86) PCT No.: PCT/EP06/04897

§ 371 Date: Jun. 27, 2008

(30) Foreign Application Priority Data
Jun. 3, 2005 (DE) 10 2005 025 570.1

(51) Int. Cl. B60N 2/28

(52) U.S. Cl. 297/250.1

(57) ABSTRACT

A child seat which can be fastened to a vehicle seat of a vehicle by means of a fastening system comprises a child belt system for securing a child sitting on the child seat apparatus for coupling a vehicle seat belt system, which has a belt strap and a belt strap tensioning device, to the belt system of the child seat. The coupling apparatus is designed such that, when the belt strap tensioning device is activated, the child seat belt system is also tensioned. The coupling apparatus has a holder into which the belt strap provided on the vehicle can be hooked. holder is designed and arranged in such a manner that it serves to receive the lap belt section of the vehicle's belt strap.

### BACKGROUND AND SUMMARY OF THE INVENTION

This application is a continuation of PCT International Application No. PCT/EP2006/004897, filed May 23, 2006, which claims priority under 35 U.S.C. §119 to German Patent Application No. 10 2005 025 570.1, filed Jun. 3, 2005, the entire disclosure of which is herein expressly incorporated by reference.

The invention relates to a child seat for a vehicle.

For the purpose of fastening a child seat to a vehicle seat, an internationally standardized fastening system is known which is referred to as the ISOFIX fastening system. The latter usually comprises two connectors which are fastened to the child seat and have snap fasteners which engage around anchoring points fastened to the vehicle floor between seat back and seat surface. Known child seats also have a belt system for securing a child sitting on the child seat.

It has been shown that, in order to obtain an optimum restraining action of the child in the child seat, belt slack in the belt system that is integrated into the child seat is to be minimized. For this purpose, German patent document DE 197 22 096 A1 discloses a child seat which has a dedicated belt system and can be fastened to a vehicle seat of a motor vehicle by a three-point seat belt on the vehicle seat. It is equipped with a tensioning device into which a shoulder belt part of the three-point seat belt of the motor vehicle is placed. The tensioning device which is integrated in the child seat is activated either directly after the three-point seat belt is placed against the child seat, or alternatively during a vehicle impact.

German patent document DE 102 51 040 A1 discloses a child seat of this type, which can be fastened to a vehicle seat by means of an ISOFIX fastening system. The vehicle seat is assigned a three-point seat belt which has a belt strap, a buckle latch provided thereon and also a tensioning device which can be accommodated, for example, in a belt retractor or in a belt buckle fixed on the vehicle. The three-point seat belt can be coupled to the belt system of the child seat, such that shortening of the three-point seat belt during an impact causes a tensioning of the belt system of the child seat. The coupling of the three-point seat belt to the belt system of the child seat therefore transmits the crash-active or preventive belt tensioning (which is generally provided in any case) of the three-point seat belt to the belt system of the child seat. Thus, a separate belt tensioner unit for the child seat can be omitted.

The three-point seat belt to the child seat belt system is coupled by inserting the buckle latch into the belt buckle, which is fixed on the vehicle body. The shoulder belt section of the belt strap is threaded or looped into a belt deflecting means interacting with the child seat belt system. The belt deflecting means is located on the rear side of the child seat backrest and comprises an upper transverse strut and a lower transverse strut, with a holder, into which the shoulder belt section can be hooked, arranged on the lower transverse strut. The holder is connected via a tightening strap to a Y-divider to which shoulder belts of the child seat belt system are fastened.

When the vehicle's belt strap tensioning device is activated, the belt slack is pulled out of the shoulder belt section of the seat belt, which leads to the holder connected to the shoulder belts of the child seat belt system, by pulling the Y-divider upward in the vertical direction. As a result, the belt slack is pulled out of the shoulder belts.

One object of the present invention is to provide a child seat of the type discussed above, having a belt system that can be tensioned preventively and/or crash-actively.

Another object of the invention is to provide such a child seat which has a cost-effective construction.

Still another object of the invention is to provide a child seat in which the coupling of the vehicle's seat belt system to the child seat belt system is simple.

These another other objects and advantages are achieved by the child seat according to the invention, in which the holder is designed and arranged to receive the lap belt section of the vehicle's belt strap, with coupling being accomplished by hooking the lap belt section into the holder. This arrangement provides a very comfortable connection which is secure during use. In addition, the risk of incorrect installation is reduced in comparison to known vehicle seats, in which the belt strap must be looped/threaded into a deflecting/belt strap tensioning mechanism.

In addition to the easy operability of the coupling means, a further advantage of the child seat according to the invention is that shortening of the belt strap of the seat belt system by means of the belt strap tensioning device during or prior to a vehicle impact causes a tensioning of the belt system of the child seat, without need of separate devices. That is, the vehicle's belt strap tensioning device builds up the required force which pulls the belt slack out of the two belt systems.

In one embodiment of the child seat, the holder is designed so that, when the vehicle's belt strap tensioning device is activated, the holder is pulled downward (as seen in the vertical direction) by the lap belt section hooked into it. This configuration eliminates the need for a deflection of the lap belt section running between an end fitting fixed on the vehicle body and a buckle latch inserted into a belt buckle.

In a preferred embodiment, the fastening system for securely fixing the child seat on the vehicle seat is an ISOFIX fastening system, as described at the beginning.

The vehicle's belt strap tensioning device serves to better restrain occupants in accidents by removing the belt slack that is present on the vehicle's seat belt when it is put on. As a result, the occupant is better coupled to the movement of the vehicle, and can be braked more compatibly.

In order to reduce force peaks that occur during an accident and exceed the maximum load-bearing capacity of the occupant, it is known to integrate force limiting elements into the vehicle's seat belt system. However, because such force limiting systems are adapted to adult occupants, the force peaks may be too high for children, and therefore a risk of injury cannot be ruled out. The force limiting levels are usually predetermined by the components in the vehicle's seat belt systems, and therefore cannot be switched to a level for restraining a child.

In the child seat according to the invention, the belt system of which is coupled to the vehicle's seat belt system, when the belt strap tensioning device is activated, in order to avoid introducing excessively high tensioning forces into the child seat belt system, which could injure the child occupying the belt system, the child seat is equipped with a force limiting system. The latter includes means for limiting the maximum belt force, and advantageously permits the belt force to be matched to the height and/or the weight of the child sitting in the child seat.

In another preferred embodiment of the child seat first belt force limiting means are formed by a deformation region of the holder. In particular, the holder is deformable, with its length being increased, when the tensioning force applied to the holder by the belt strap tensioning exceeds a certain threshold value. In this embodiment, the belt force limiting means are therefore integrated into the belt system of the child seat. A child located in the child seat is therefore always provided with a force limiting system corresponding to the class of child seat. By interchanging the holder, it is possible to match the belt force limiting, for example to the height or the weight of the child.

The deformation region of the holder can have, for example, a corrugated design such that it stretches in a specific manner under a defined load. The geometry, (for example the thickness, width number and design of the corrugations, an additional perforation and the like) and the material-specific properties make it possible to set a defined deformation of the deformation region and therefore a desired force limiting level in a specific manner. A desired force limiting characteristic can therefore be achieved by appropriate design of the holder and/or of the deformation region. Because of the arrangement of the holder on the rear side of the backrest of the child seat, the holder hardly interferes when strapping in the child.

In another preferred embodiment of the child seat, second belt force limiting means are provided which are formed in such a manner that the at least one shoulder belt and/or the tightening strap of the child seat belt system have at least one loop fastened with at least one tear seam. This may be an individual loop or a double or multiple loop which is held together by at least one tear seam, if appropriate with the aid of at least one connecting strap. A tear seam is understood as being a seam which tears in a controlled manner under a defined force. According to the invention, a desired force limiting characteristic is produced in a defined manner by the tearing property of the tear seam thread itself and by the number, position and orientation of the tear seam or of the tear seams. This force limiting characteristic can be matched, for example, to the weight group of the particular child seat. Furthermore, this force limiting characteristic can be influenced by the design of the geometry of the belt strap. If the breaking load of the tear seam is exceeded and the latter tears, an additional forward displacement of the child comes about for a limited distance, which reduces the forces acting on the child sitting on the child seat, and therefore the risk of injury to the child.

A feature common to all of the belt force limiting means is that they reduce the tensioning force of the vehicle's belt strap tensioning device, which tensioning force is otherwise matched to adults, to a force limiting level tolerable for children by deformation of the holder and by specific tearing of tear seams specially provided for this purpose.

Other objects, advantages and novel features of the present invention will become apparent from the following detailed description of the invention when considered in conjunction with the accompanying drawings.

### BRIEF DESCRIPTION OF THE DRAWINGS

FIG. 1 is a rear perspective view of a first exemplary embodiment of a child seat according to the invention;

FIG. 2 is a side view of the child seat according to FIG. 1;

FIG. 3 is a perspective view of an embodiment of a holder for the connection of a vehicle's belt strap;

FIG. 4 is a side view of the holder according to FIG. 3;

FIGS. 5A, 5B illustrate a second embodiment of the holder;

FIG. 6A is a sectional illustration of a shoulder belt of a child seat belt system in the region of a loop which is provided with a plurality of tear seams;

FIGS. 6b to 6f show an exemplary embodiment of the loop with different tear seam arrangements in plan view; and

FIGS. 7 and 8 each show a perspective illustration of a further exemplary embodiment of the child seat from the rear.

### DETAILED DESCRIPTION OF THE DRAWINGS

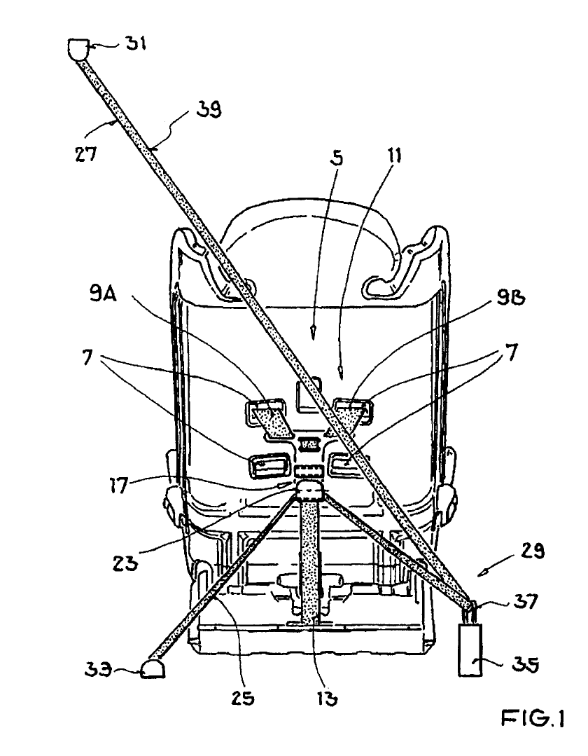

FIGS. 1 and 2 each show an illustration of a child seat 1 which can be fastened to a vehicle seat (not illustrated) of a vehicle by means of a fastening system, for example an ISOFIX fastening system. The child seat 1 has a seat shell 3 with a backrest 5 that has passage openings 7 through which shoulder belts 9A and 9B of a belt system 11 for the child seat 1 are guided to the front side of the backrest 3. Furthermore, the belt system 11 has a tightening strap 13 which is guided from the rear of the child seat to the side of the child seat 1 which is also accessible when the child seat 1 is installed in the vehicle. The tightening strap 13 is used to tension the shoulder belts 9A, 9B when placed onto the child, and the tightening strap 13 is fixed in this position by a clamping device (not shown). After the tightening operation, belt slack remains in the belt system 11 and may have a negative effect for the child in the event of a crash.

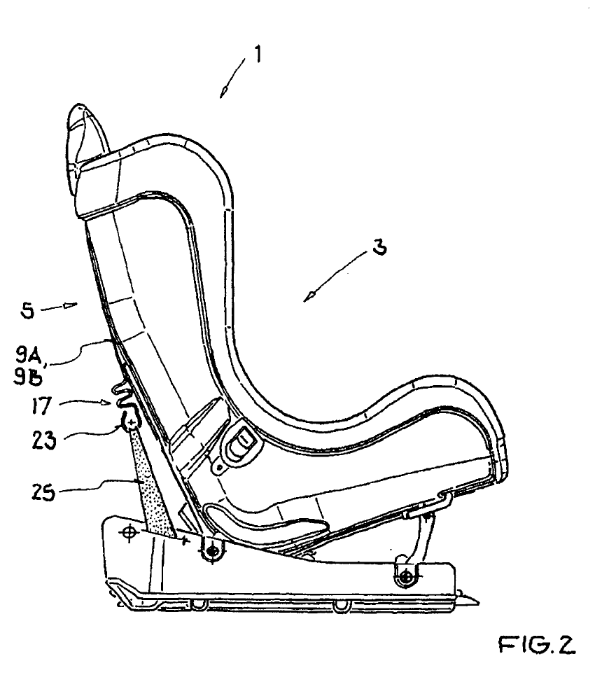

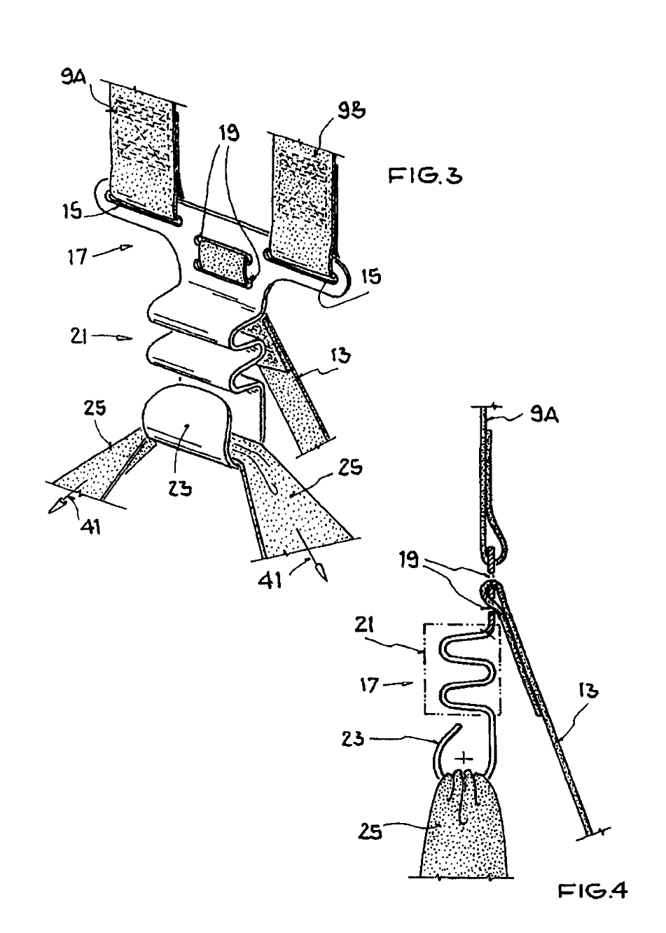

As is apparent from FIGS. 1 and 3, the shoulder belts 9A and 9B are guided through slot-shaped passage openings 15 in a holder 17 which is produced from sheet metal and is of essentially T-shaped design, as seen in plan view. The holder 17 has further passage openings 19 through which the tightening strap 13 is guided. A deformation region 21 formed by a corrugated section is provided on the holder 17. A hook 23 is provided at the free end of the deformation region 21. In FIG. 4, the deformation region 21 is delimited by a broken line for illustrative reasons.

In the fitted state of the child seat 1, a lap belt section 25 of a vehicle's belt strap 27, which is part of a vehicle's seat belt system 29, is hooked into the hook 23, thereby coupling the vehicle's seat belt system 29 to the child seat belt system 11.

As shown in FIG. 1, the seat belt system 29 has an upper deflector 31, an end fitting 33 and a belt buckle 35, which are fixed on the vehicle body. A buckle latch 37 on the belt strap 27 is inserted into the belt buckle 35. The belt strap 27 is fastened at one end to the deflector 31 and at its other end to the end fitting 33, and is deflected in the region of the buckle latch 37. As a result, the belt strap 27 is divided into the lap belt section 25 located between the end fitting 33 and the buckle latch 37 and a shoulder belt section 39 located between the deflector 31 and the buckle latch 37. This type of belt arrangement is also known as a three-point seat belt.

The holder 17 is arranged on the child seat 1 is in such a manner that the hook 23 is open upward and is located above the end fitting 33 and the belt buckle 35 in the vertical direction. The lap belt section 25 is therefore hooked in from above and deflected by the holder 17 so that it has a V-shaped profile.

The seat belt system 29 further comprises a belt strap tensioning device (not shown) which may comprise, for example, a belt retraction tensioner, a belt buckle tensioner and/or an end fitting tensioner. Belt tensioners of this type serve to pull out a belt slack in the vehicle's seat belt system and are known per se, and therefore are not discussed in more detail here. By hooking the lap belt section 25 into the holder 17 of the child seat 1, the function of the vehicle's belt strap tensioning device is used at the same time for the child seat belt system 11 (that is, the tensioning force built up by means of the belt strap tensioning device pulls the belt slack out of both belt systems 11, 29).

Due to the coupling of the belt systems 11, 29, activation of the belt strap tensioning device shortens the lap belt section 25, which in turn leads to the holder 17. The shoulder belts 9A, 9B fitted thereto and the tightening strap 13, are pulled downward in the direction of gravitational force. Shifting of the holder 17 causes the belt slack to be pulled out of the child seat belt system 11.

In addition or as an alternative to the abovementioned belt tensioning systems of the vehicle's seat belt system 29, an electric motor belt strap tensioner, as used, for example in PRE-SAFE systems, may also be provided. A preventive and reversible tensioning at a reduced force level takes place in this case. The function of such a system may also be used, due to the coupling of the vehicle's seat belt system to the child seat belt system according to the invention, for preventive tensioning of the child seat belt in or immediately before a hazardous situation. In addition, the tightening strap 13 can be supported during the operation, to strap in the child so as to avoid excessive belt slack.

With the construction according to the invention, fitting of the child seat 1 into the vehicle is extremely simple. To couple the vehicle's seat belt system 29 to the child seat belt system 11, first the lap belt section 25 of the vehicle's belt strap 27 is hooked into the holder 17. Subsequently, the child seat 1 can be anchored with its ISOFIX connectors to the vehicle's ISOFIX anchoring points. The vehicle's belt strap 27 does not need to be looped/threaded into a deflecting/belt strap tensioning mechanism provided for this purpose, as is required in the case of the known child seat. High functional reliability can be ensured.

The above-described child seat 1 is provided with belt force limiting means which reduce a matching of the tensioning forces transmitted to the child seat belt system 11 by the vehicle's belt strap tensioning device, in particular the force peaks during the forward displacement of the child in the event of a crash, to an extent tolerable to the child located in the child seat 1. In this exemplary embodiment, the belt force limiting means are formed by the deformation region 21 of the holder 17. The latter begins to stretch after a certain threshold value of the tensioning force 41 (that is, below a defined load which is introduced into the holder 17 by means of the lap belt section 25). It is possible to match the force level of the child seats belt force limiter to, for example, the height or the weight of the child, for example, by appropriate dimensioning and/or geometry of the deformation region and/or specific weakening of the same. By interchanging a provided holder 17 for a different holder matched to parameters (height, weight) of the child, a simple conversion of an existing child seat is possible.

The holder 17 described with reference to FIGS. 1 to 4 is a sheet-metal component which is of single-part design and can be produced cost-effectively.

In a particularly preferred embodiment, the child seat 1 is fastened in the vehicle by means of the ISOFIX fastening system and a toptether support.

If the vehicle's seat belt system 29 (usually a three-point seat belt system) has a pyrotechnic belt tensioner, the belt system 11 of the child seat 1 is tensioned in the event of a crash. If, in addition, a preventive protective system is provided for the vehicle's three-point seat belt, tensioning of the belt system 11 of the child seat 1 can take place crash-actively and preventively.

FIGS. 5A and 5B show a further exemplary embodiment of the holder 17. Identical parts are provided with the same reference numbers, and therefore reference is made in this respect to the description of FIGS. 1 to 4. The holder 17 has a two-part design. A first part 43, which has the passage openings 15 and 19 for the shoulder belts 9 and the tightening strap 13, is of planar/plate-like design, while a second part 45, which has the deformation region 21 and the hook 23, is connected fixedly to the first part 43. This configuration permits the holder 17 to be designed with a shortened length Lo while retaining the same functionality.

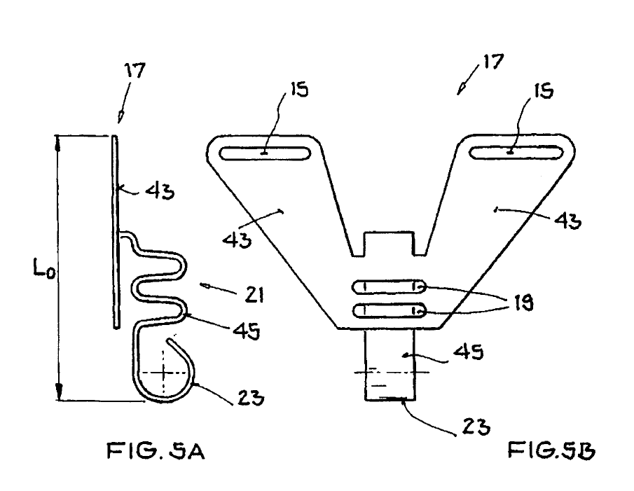

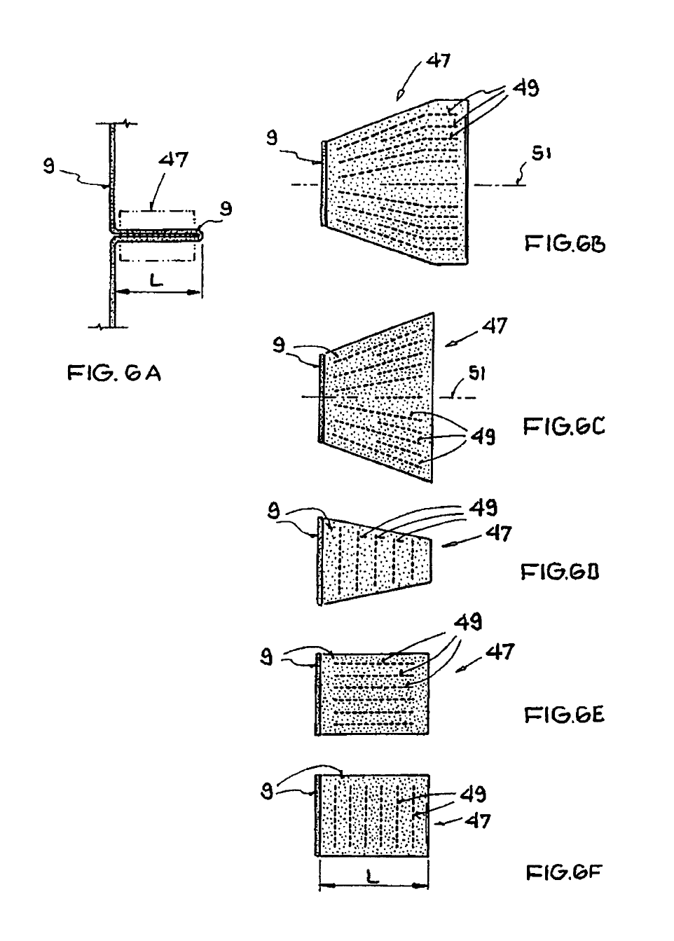

The above-described child seat 1 can also be provided with a second belt force limiting means, as described below with reference to FIGS. 6A to 6F.

FIG. 6A shows a detail of one of the shoulder belts 9 of the child seat belt system 11 in the region of a single loop 47 with the length L, which is provided with a plurality of tear seams (not visible in FIG. 6A). The tear seams tear in a controlled manner under a defined force.

The force limiting profile/force limiting characteristic which can be realized by means of the second belt force limiting means can be set in a defined manner, inter alia, by variation of the number, position and orientation of the tear seams, the cut of the belt strap and the tearing properties of the thread. This force limiting characteristic can be matched to the weight group of the particular child seat.

FIGS. 6B to 6F illustrate advantageous exemplary embodiments of the loop 47 with different tear seam constructs.

In the embodiment according to FIG. 6B, the loop 47 in plan view has a shape similar to a trapezoid, with the tear seams 49 being arranged mirror-symmetrically with respect to an imaginary loop longitudinal center axis 51. Apart from the tear seam lying on the longitudinal center axis 51, the tear seams 49 have an angled profile. Some of the tear seams 49 have different lengths.

In the exemplary embodiment according to FIG. 6C, the loop 47 in plan view has a trapezoidal shape, with the tear seams 49, which are arranged mirror-symmetrically with respect to a longitudinal center axis 51, having a linear profile.

The exemplary embodiment according to FIG. 6D differs from that of FIG. 6C essentially in that the cut of the loop 47 is designed so that the side of the trapeze having the smaller length is located on the closed side of the loop. The tear seams 49, which run parallel to one another, are arranged transversely with respect to the longitudinal extent of the loop.

In the exemplary embodiment according to FIG. 6E, the loop 47 has a rectangular shape. The linear tear seams 49, which run parallel to one another, run in the direction of the longitudinal extent of the loop while, in the otherwise identical exemplary embodiment according to FIG. 6F, the tear seams run transversely with respect to the longitudinal extent of the loop.

In addition or as an alternative, the tightening strap 13 may also be provided with at least one loop 47 which is held together by means of at least one tear seam 49, as described above.

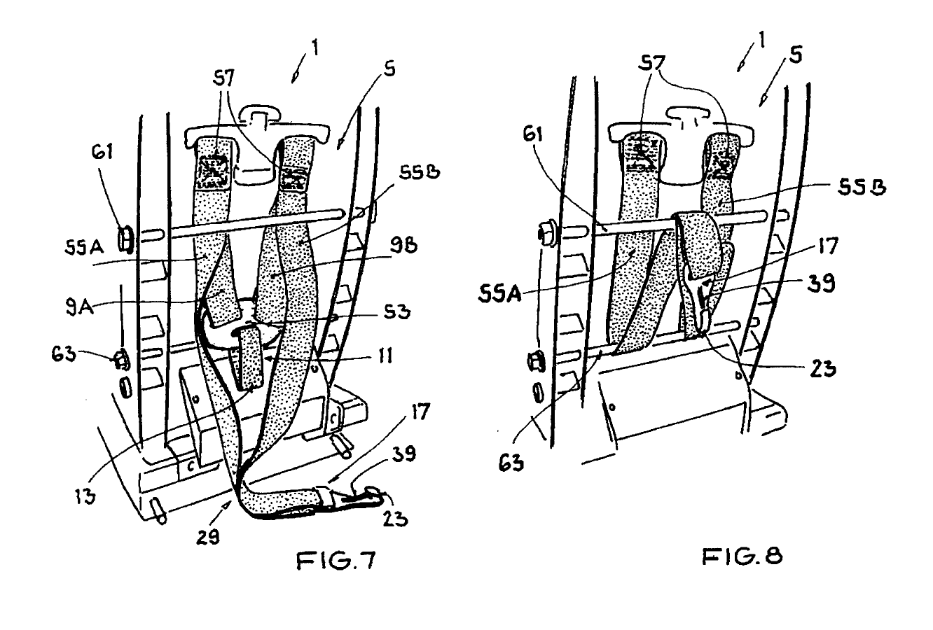

FIGS. 7 and 8 each show a perspective cutout view of a further exemplary embodiment of the child seat 1. Parts which have already been described with reference to the previous figures are provided with the same reference numbers. Only the important differences are discussed in more detail below. The shoulder belts 9A and 9B and the tightening strap 13 are fastened to a connecting component 53 or are looped through passage openings provided thereon. A respective coupling strap 55A and 55B is fastened to the shoulder belts 9A, 9B by means of at least one tear seam 57 in each case. The coupling straps 55A, 55B are fastened at their free ends to the holder 17 or are looped through it, the holder having a hook 23 into which the lap belt section 25 of the vehicle's seat belt system 29 is hooked. The hook 23 is provided with a spring catch 59 for securing the lap belt section 25 against unintentional removal.

As is apparent from FIGS. 7 and 8, fixed deflecting elements 61 and 63, via which the coupling straps 55A and 55B are guided, are fitted on the rear side of the backrest 5. The deflecting elements are formed here by rods with a circular cross section. The advantage of this entire arrangement is that it provides sufficient tensioning distance of the belt systems 11, 29 with respect to the vehicle's lap belt section 25 in all positions of the belt profiles of the child seat 1. In FIG. 8, the coupling straps 55 are guided via the deflecting elements, and therefore the lap belt section 25 of the seat belt system 29 needs only to be hooked into the hook 23. For the purpose of being better able to see the connecting component 53, the coupling straps 55 are shown in FIG. 7 in the state in which they are not looped in.

An advantage in the exemplary embodiment according to FIGS. 7 and 8 is that force limiting is realized by means of the tear seams 57. Furthermore, force limiting can be realized by appropriate configuration, arrangement and mounting of the deflecting elements 61 and 63, as described in particular in German patent document DE 101 07 874 A1.

In summary, the child seat 1 according to the invention permits simple coupling to occupant restraint systems provided in vehicles and provides optimum coordination of the forces acting on the child located in the child seat when the vehicle's belt strap tensioning device is activated. The belt systems 11 and 29 can be coupled very comfortably and simply, so that the risk of erroneous operation is reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-12. (canceled)

13. A child seat having a fastening system for fastening the child seat to a vehicle seat, said child seat comprising:
a child belt system for securing a child sitting on the child seat;
means for coupling the child belt system to a vehicle seat belt system having a belt strap and a belt strap tensioning device; wherein,
the coupling means has a configuration such that, when the belt strap tensioning device is activated, the child belt system is also tensioned;
the coupling means has a holder into which the belt strap provided on the vehicle can be hooked; and
the holder is configured and arranged in such a manner that it serves to receive a lap belt section of the vehicle's belt strap.

14. The child seat as claimed in claim 13, wherein the holder is configured such that, when the vehicle's belt strap tensioning device is activated, said holder is pulled downward, relative to a vertical direction, by the lap belt section hooked into it.

15. The child seat as claimed in claim 13, wherein the holder has a hook into which the lap belt section can be hooked.

16. The child seat as claimed in claim 15, wherein the hook is configured such that, when the belt strap tensioning device is activated in the longitudinal extent of the belt strap, the lap belt section can be pulled through.

17. The child seat as claimed in claim 13, wherein at least one of a shoulder belt and a tightening strap of the child belt system is coupled to the holder.

18. The child seat as claimed in claim 13, wherein the child seat has belt force limiting means which permit the maximum belt force to be matched to the height or weight of a child sitting in the child seat.

19. The child seat as claimed in claim 18, wherein:
the belt force limiting means includes a first belt force limiting device are formed by a deformation region of the holder;
the holder can be deformed, increasing its length in response to application of a certain threshold value of a tensioning force to the holder by means of the belt strap tensioning device.

20. The child seat as claimed in claim 18, wherein the belt force limiting means includes a second belt force limiting device formed such that the at least one of a shoulder belt and the tightening strap of the child belt system is provided with at least one loop fastened with at least one tear seam.

21. The child seat as claimed in claim 17, wherein:
the belt force limiting means includes a third belt force limiting device formed by the connecting holder to the at least one child seat shoulder belt via at least one coupling strap; and
the coupling strap is fastened to the child seat shoulder belt by at least one tear seam.

22. The child seat as claimed in claim 21, wherein the coupling strap is guided via at least one deflecting element.

23. The child seat as claimed in claim 13, wherein the holder is formed as a single piece.

24. The child seat as claimed in claim 13, wherein the holder is fitted to the child seat such that it can be interchanged.

25. The child seat as claimed in claim 19, wherein the deformation region comprises a deformable corrugated portion.

26. The child seat as claimed in claim 23, wherein the single piece comprises a sheet metal part.
